(19) United States
(12) Patent Application Publication
(10) Pub. No.: US 2009/0262194 A1
(43) Pub. Date: Oct. 22, 2009

(54) Interactive Media and Game System for Simulating Participation in a Live or Recorded Event

(75) Inventors: Ivan Nelson Wakefield, Cary, NC (US); William O. Camp, JR., Chapel Hill, NC (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 12/107,306

(22) Filed: Apr. 22, 2008

(51) Int. Cl. H04N 7/18

(52) U.S. Cl. 348/157; 348/E07.085

(57) ABSTRACT

An interactive media and game system creates a live event simulation that enables users to participate in a live event through a virtual participant controlled by the user. A game server receives user input controlling a position of a virtual participant in said live event, determines a position and orientation of the virtual participant based on said user input, and creates a simulated view of the event from the perspective of the virtual participant. To create the simulated view, the game server selects a video source from among a plurality of video sources based on the position of the virtual participant, determines a position and orientation of the selected video source, and transforms a video image supplied by the selected video source based on the position and orientation of the selected video source relative to the virtual participant. Transforming may entail interpolating between two or more video images from two of more different video sources.

### BACKGROUND

The present invention relates generally to game simulations and, more particularly, to interactive media and game system that enables users to participate in live event simulation.

A video game is a game typically played on a computer that generates visual output responsive to user input. With advancements in computer and video processing technology, video games have evolved from the relatively simple images and game play in titles such as PONG, to visually rich graphics and complex game play in modern video games such as CALL OF DUTY. Some modern video games simulate sporting events such as football, basketball and hockey. In these modern video games, users interact with a computer generated virtual environment.

Recently, there has been an interest in interactive media. Interactive media comprises media that allows the viewer to become an active participant in a media program. The interactive media program may be a broadcast program or a recorded program. As one example, an interactive media program may allow users to cast votes for participants in a talent competition such as AMERICAN IDOL that is broadcast live to viewers. Typically, the interaction events for interactive media programs are predefined and support only limited interactions by the user.

### SUMMARY

The present invention combines interactive media with a video game to enable users to become virtual participants in live events. An interactive media and game system creates a live event simulation that enables users to participate in a live event through a virtual participant controlled by the user. A game server receives user input controlling a position of a virtual participant in said live event, determines a position and orientation of the virtual participant based on the user input, and creates a simulated view of the event from the perspective of the virtual participant. To create the simulated view, the game server selects at least one video source from among a plurality of video sources based on the position of the virtual participant, determines a position and orientation of the selected video source, and transforms a video image supplied by the selected video source based on the position and/or orientation of the selected video source relative to the virtual participant. As described above, the construction of a simulated view may involve transforming operations such as scaling a video feed from a selected video source, interpolating between corresponding points in two or more video images provided by different video sources, and/or scaling of an intermediate image generated by interpolation.

In one exemplary embodiment, the game server may edit one or more of the video images prior to the transforming operations to eliminate objects in the view of one or more video sources that are not in the view of the virtual participant in order to construct the simulated view. In other embodiments, the construction of a simulated view may further require combining virtual elements with the real-world video images from one or more the video sources. For example, in a multiplayer game, one virtual participant may be in the view of another virtual participant. In this case, the game server will need to generate a view of the virtual participant based on the event models to be added to the simulated view.

The present invention includes methods of simulating participation in a live event. One exemplary method comprises receiving user input controlling a virtual participant in said live event, determining a position of a virtual participant in the live event based on said user input, selecting a video source based on the position of the virtual participant, determining a position of the selected video source, and transforming a video image from the selected video source based on the position of the selected video source and the position of the virtual participant to generate a simulated view from a viewpoint of the virtual participant.

In one exemplary method, transforming a video image from the selected video source comprises scaling a video image provided by a single video source based on a distance of said virtual participant and a distance of said video source from one or more objects in the view of said video image.

In one exemplary method, transforming a video image from the selected video source comprises interpolating between two or more video images from two or more selected video sources.

In one exemplary method, transforming a video image from the selected video source comprises interpolating between two or more video images from two or more selected video sources to generate an intermediate view, and subsequently scaling the intermediate view based on a distance of said virtual participant and a distance of said intermediate view from one or more objects in the view of said video images.

The exemplary methods may further comprise editing said video image from said image source prior to transforming said video image to delete objects in the view of the video source but not in the view of the virtual participant.

The exemplary methods may further comprise determining an orientation of said virtual participant based on said user input.

In one exemplary method, the transforming is further based on said orientation of said virtual participant and on an orientation of said video source.

The exemplary methods may further comprise combining virtual elements with said video image to generate said simulated view.

In one exemplary method, combining virtual elements with said video image comprises combining a computer-generated image of a second virtual participant with said video image to create a simulated view for a first virtual participant.

The exemplary methods may further comprise highlighting one or more participants in said simulated view.

The exemplary methods may further comprise adding information labels about said real and/or virtual participants to said simulated view.

In one exemplary method, the user input is received from a user device at a computing device, and said computing device generates said simulated view and further transmits said simulated view over a communication network to said user device for display to said user on a display of said user device.

In one exemplary method, a user device generates said simulated view and further outputs said simulated view to a display on said user device.

Embodiments of the invention further comprise an interactive media and game system for creating a live event simulation. The interactive media and game system comprises according to one embodiment comprises an event simulation processor configured to create a live event simulation and to determine a position of a virtual participant based on user input; and a video processor configured to select a video source based on the position of the virtual participant, determine a position of the selected video source, and transform a video image from the selected video source based on the position of the selected video source and the position of the virtual participant to generate a simulated view from a viewpoint of the virtual participant.

In one exemplary system, the video processor is configured to transform a video image from the selected video source by scaling a video image provided by a single video source based on a distance of said virtual participant and a distance of said video source from one or more objects in the view of said video image.

In one exemplary system, the video processor is configured to transform a video image from the selected video source by interpolating between two or more video images from two or more selected video sources.

In one exemplary system, the video processor is configured to transform a video image from the selected video source by interpolating between two or more video images from two or more selected video sources to generate an intermediate view and subsequently scaling the intermediate view based on a distance of said virtual participant and a distance of said intermediate view from one or more objects in the view of said video images.

In one exemplary system, the video processor is configured to edit said video image from said image source prior to transforming said video image to delete objects in the view of the video source but not in the view of the virtual participant.

In one exemplary system, the event simulation processor is further configured to determine an orientation of said virtual participant based on said user input.

In one exemplary system, the video processor is further configured to transform said video image based on an orientation of said virtual participant and an orientation of said video source.

In one exemplary system, the video processor is configured to combine virtual elements with said video image to generate said simulated view.

In one exemplary system, the interactive media and game system video processor is configured to combine a computer-generated image of a second virtual participant with said video image to create a simulated view for a first virtual participant.

In one exemplary system, the interactive media and game system the video processor is further configured to highlight said one or more participants in said simulated view.

In one exemplary system, the video processor is further configured to add information labels about said real and/or virtual participants to said simulated view.

### BRIEF DESCRIPTION OF THE DRAWINGS

FIG. 1 illustrates an exemplary interactive media and game system according to one exemplary embodiment.

FIG. 2 illustrates an exemplary game server for the interactive media and game system.

FIG. 3 illustrates an exemplary processor in a game server for creating a live event simulation.

FIG. 4 illustrates a method for generating a simulated view of a live event from a single video source.

FIG. 5 illustrates a method for generating a simulated view of a live event from two video sources.

FIG. 6 illustrates a method for generating a simulated view of a live event from three or more video sources.

FIG. 7 illustrates an alternate method for generating a simulated view of a live event from two video sources.

FIG. 8 illustrates a method implemented by a game server for creating a live event simulation.

### DETAILED DESCRIPTION

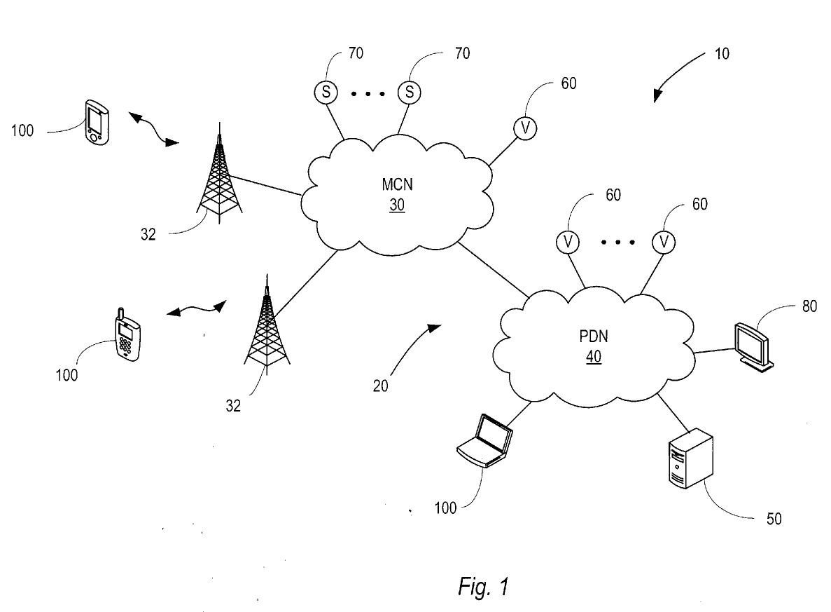

Referring now to the drawings, FIG. 1 illustrates an exemplary interactive media and game system 10 according to one exemplary embodiment that allows users to become a virtual participant in a live event. The interactive media and game system comprises a game server 50 providing interactive media and game services to authorized users. Video sources 60 provide live video and audio feeds covering the live event to the game server 50. Remote sensors 70 collect data related to the live event and provide the collected data to the game server 50. For example, the remote sensors 70 may collect data related to the position and performance of real participants in the live event. The game server 50 produces a simulation of the live event that mixes video, audio, and sensor data from the live event with computer-generated elements to create a live event simulation.

According to the present invention, the game server 50 creates a virtual participant controlled by a user to enable the user to participate in the live event. User devices 100 enable the user to control a virtual participant and/or events in the live event simulation by transmitting control signals to the game server 50. The game server 50 generates video and/or audio for the live event simulation, referred to as the game video, which may be transmitted back to the user device 80 for output to the user via the user device 100. Alternatively, the game video may be output to a separate media system 80 including a display and speakers for rendering video and audio to the user.

A communication network 20 interconnects the game server 50, video sources 60, remote sensors 70, media system 80, and user devices 100. In the exemplary embodiment, the communication network 20 comprises a mobile communication network 30 and a conventional packet data network (PDN) 40. The mobile communication network 30 provides packet data services to mobile user devices 100, such as cellular phones, personal digital assistants, portable game devices, and laptop computers. The mobile communication network 30 includes one or more base stations or access points 32 for communicating with mobile user devices 100 and may operate according to any conventional standard, such as the GSM, WCDMA, WiFi, WiMAX, and LTE standards. Mobile communication network 30 connects to the PDN 40. PDN 40 may comprise a public or private network, and may be a wide area or local area network. The Internet is one well-known example of a PDN 40.

FIG. 1 illustrates one possible arrangement of elements within the communication network, although other arrangements are certainly possible. In the embodiment shown in FIG. 1, the game server 50 and video sources 60 preferably connect to the PDN 40. The video sources 60 generate large amounts of data that need to be transmitted to the game server 50. The PDN 40 can provide high data rate, low latency, and low cost connections for transmitting data from the video sources 60 to the game server 50. Those skilled in the art will appreciate, however, that the video sources 60 may alternatively connect to the mobile communication network 30 when there is a need for the video sources 60 to be mobile. Wireless broadband connections currently being implemented, or that may be developed in the future, can provide sufficient bandwidth for transmitting video and/or audio over wireless links. The media system 80, if present, preferably connects to the PDN 40.

The remote sensors 70 will typically generate less data than the video sources 60. Further, there may be a need in many circumstances for the remote sensors 70 to be mobile. Accordingly, the remote sensors 70 are shown in the exemplary embodiment connected to the mobile communication network 30. The remote sensors 70 may, for example, comprise, location sensors to monitor the location of real participants in the live event, and various types of sensors to monitor performance of the live participants. The location sensor for participants may take the form of a global positioning system (GPS) receiver. Performance monitoring sensors may comprise speedometers, accelerometers, motion sensors, proximity detectors, and other type of sensors as required by the needs of a particular live event simulation. Remote sensors 70 may also be provided for monitoring environmental conditions such as temperature, wind speed, lighting conditions, etc. Remote sensors 70 are also used to provide data about the position and orientation of said video sources 60 to enable generation of simulated views of the live event as hereinafter described.

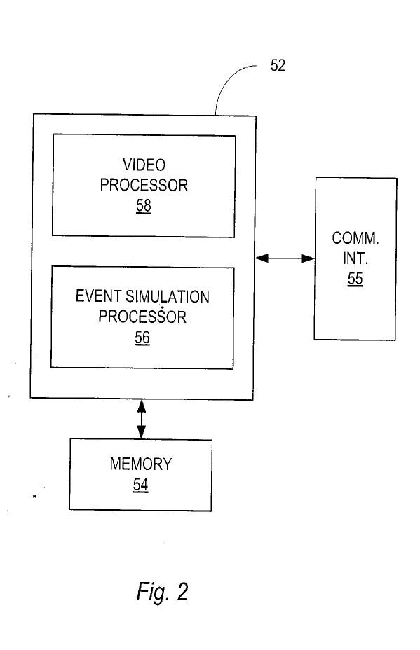

FIG. 2 illustrates an exemplary game server 50 according to one embodiment. The game server 50 comprises a computer having processing circuits 52, memory 54, and a communication interface 55. The processing circuits 52 comprise one or more processors, hardware circuits, or a combination thereof for creating a live event simulation as hereinafter described. Computer executable code and data for creating the live event simulation are stored in memory 54. Communication interface 60 enables communication between the game server 50 and other elements of the interactive media and game system 10. The communication interface 55 may comprise a wired or wireless interface. For example, the communication interface may comprise an Ethernet interface, high speed serial (e.g, USB) or parallel interface (e.g. Firewire), wireless local area network (WLAN) interface (e.g., WiFi or WiMax), or a wireless broadband interface (e.g., WCDMA or LTE).

The processing circuits 52 comprise an event simulation processor 56 and a video processor 58. Event simulation and video processing may be carried out by a single processor or by multiple processors. The details of the processor architecture are not material to the invention. The function of the event simulation processor 56 is to create a live event simulation with a virtual participant controlled by a user. Both single player and multi-player simulations may be created. The event simulation processor 56 receives control input form one or more user devices 100 controlling the virtual participants in the live event simulation. The event simulation processor 56 simulates the virtual participants and their respective interactions with real participants based on the event models and outputs viewpoint data to the video processor 58 indicating the position and/or orientation of the virtual participant being controlled by the user. The function of the video processor 58 is to create a simulated view of the live event from the perspective of the virtual participant being controlled by the user. The video processor 58 also receives video input from a plurality of video sources 60. The simulated view is generated by transforming video images from one or more selected video sources 60. Some embodiments may further involve editing video images prior to transformation to eliminate objects not in the field of view of the virtual participants, and/or mixing computer generated images with the live video images from the video sources 60 to generate simulated views of virtual participants.

The user devices 100 may comprise a desktop or laptop computer, a cellular phone, a PDA, an hand-held game device, or other computing device with a connection to the communication network 20. The user device 100 will typically comprise a user input device, such as a keypad, keyboard, joystick, and game controller to enable the user to control the virtual participant. Further, the user device 100 may further include a display to display the simulated view generated by the game server 50 as hereinafter described. However, it is not necessary for the user device 100 to include a display, since the simulated view can be displayed on a separate display monitor 80.

The game server 50 generate a live event simulation for any type of live event. Examples of live events comprise auto races, boat and yacht races, motorcycle races, skiing, as well as sporting events such as football, basketball, and hockey. The type of event is not limited to sporting events, but may also include other types of live events such as concerts and parades.

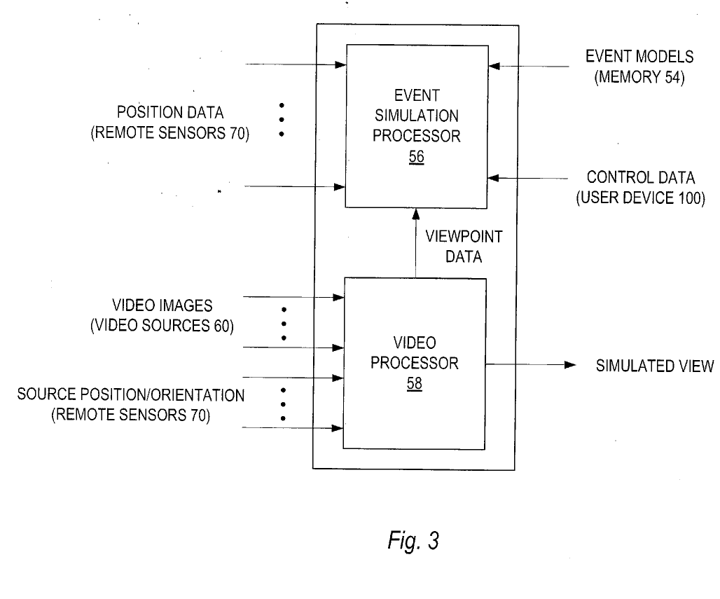

Referring now to FIG. 3, an exemplary embodiment of the interactive media and game system 10 is shown for creating a live event simulation of an auto race. FIG. 3 illustrates the various inputs to and outputs from the event simulation processor 56 and video process 58 for simulating an automobile race. In this exemplary embodiment, the inputs to the event simulation processor comprise position data provided by remote sensors 70, event models which are stored in memory 54, and control data provided by the user devices 100. The position data indicates the position of the real race cars in the live event. The position data may be provided by GPS location sensors mounted on the race cars. The event models include 3D models of the race track and race cars that are participating in the live event. The control data comprises data from the user device 100 for controlling the simulated race car. In this example, the user can control the speed and direction of a simulated race car to race against the real participants in the live event.

The event simulation processor 56 models interactions between the real participants in the live event and simulated participants based on the position data, event models and control data. The event simulation processor 56 may impose or enforce rules for interactions between simulated participants and real participants. For example, a simulated participant may have his or her path blocked by a real race car in the live event. In this case, the game simulation processor 56 would prevent the simulated participant moving through or occupying the same apace as the real race car. As another example, the user may maneuver a simulated race car into the draft of a real race car. Such interactions will, of course, be dependent upon the nature of the live event. Rules for interactions between virtual participants in a multi-player game may be applied in the same manner. Based on the rules of the live event simulation, the event processor 56 outputs to the video processor 58 viewpoint data representing the position and/or orientation of the simulated race car controlled by the user.

The primary function of the video processor 58 is to generate a view of the live event from the perspective of the virtual participant, i.e., simulated race car. According to embodiments of the present invention, a plurality of video sources 60 provide live video feeds to the video processor 58. The video processor 58 selects one or more live video feeds depending upon the current position and/or orientation of the virtual participant and transforms and/or combines the video images from the selected video sources 60 to create a simulated view of the live event from the perspective of the virtual participant. According to the present invention, a simulated view of the live event is generated using a technique referred to herein as view morphing. View morphing allows a simulated view to be generated without the use of 3D models. The basic concept of view morphing is to generate a simulated view by transforming and/or combining live video images from one or more selected video sources 60. The video sources 60 provide real-world views of the event from different positions and angular orientations. The video processor 58 selects a video image from one or more video sources 60 depending upon the current position of the virtual participant. The position of the virtual participant is provided by the event simulation processor 56 as part of the viewpoint data. The video processor 58 may then transform the selected video image or images based on the position of the virtual participant.

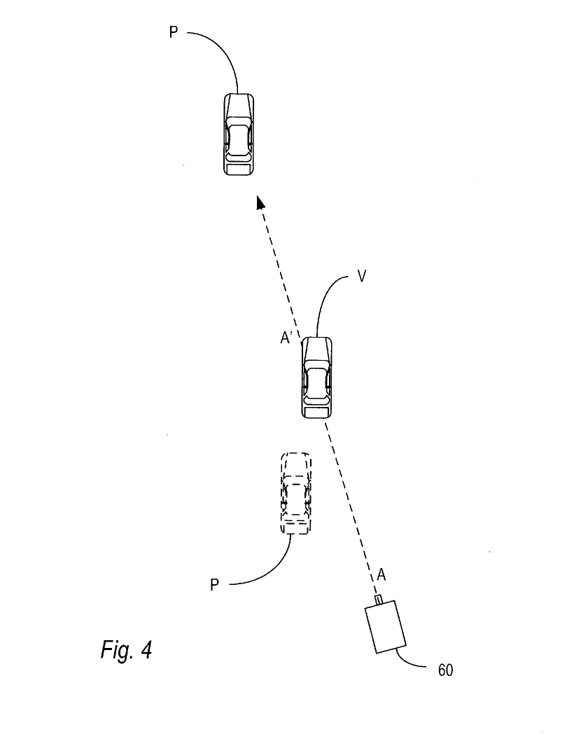

In some scenarios, it may be possible to select a singe video source 60. This situation may occur, for example, when the current position of the virtual participant is in line with a video source 60 as shown in FIG. 4. FIG. 4 shows a single video source 60 providing a real-world view A of the live event, a real participant P (in solid lines) and one virtual participant V. In this case, the live image from the selected video source 60 can be scaled based on the distance of the virtual participant and the distance of the video source 60 the objects in the view of the video source 60 to reflect the location of the virtual participant. Even when the virtual participant is not exactly in line with the selected video source 60, the view from the video source 60 can be translated accordingly. FIG. 4 also shows a second real participant (in dotted lines) trailing the virtual participant, but in the field of view of the video source 60. In this case, the video processor 58 may edit the video image from the video source 60 prior to the transforming operations to eliminate objects in the view of the video source 60.

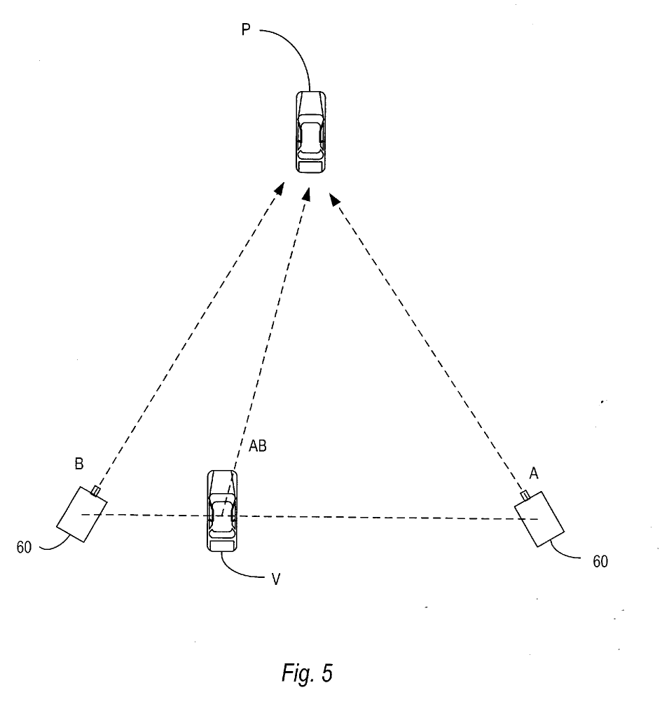

In cases where the virtual participant is too far removed from the sight lines of the video sources 60, view morphing can be accomplished using video images from two or more video sources 60 as shown in FIG. 5. FIG. 5 illustrates a simple example of view morphing using video images from two video sources 60. FIG. 5 illustrates two video sources 60 providing real-world views A and B respectively. Also shown are a real participant P and a virtual participant V. When two video images are available, a simulated view AB at a point along a line connecting the two video sources 60 can be generated. Techniques for view morphing with two video sources 60 are known. To briefly summarize, the video images from the video sources 60 are pre-morphed to form parallel views. An intermediate view is then generated by interpolating points on these parallel views. Post-morphing is then applied to transform the image plane of the intermediate view to a desired position and orientation to create the final simulated view.

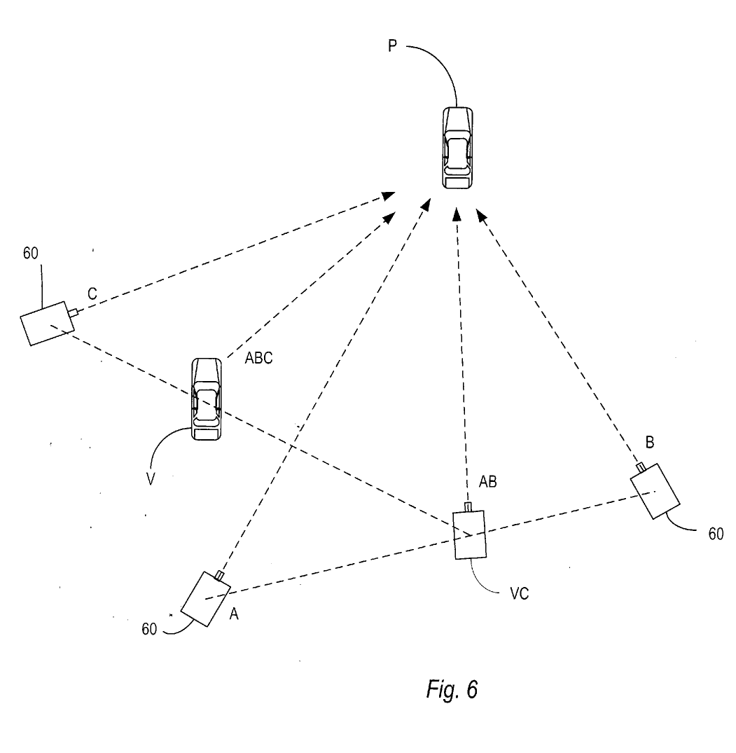

Those skilled in the art will appreciate that the view morphing techniques described above can be used to morph live video feeds from three or more video sources 60 to generate a view from virtually any location on the race track provided that there are a sufficient number of video sources 60 to cover the entire race track. Referring to FIG. 6, video sources 60 providing real-world views A, B and C respectively are shown. Also shown are a real participant P and a virtual participant V. The video processor 58 first generates a simulated view AB from the perspective of virtual camera VC by morphing the live video images from the two video sources 60 providing views A and B. The simulated view AB from the perspective of virtual camera VC can then be used the same as a live video feed to perform additional transformation operations. In this case, the simulated view AB and the view C from the third video source 60 are transformed to generate a simulated view ABC from the perspective of the virtual participant V. As with the embodiment shown in FIG. 4, the video image from one or more video sources 60 may be edited prior to the transformation operations to eliminate real-world objects in the filed of view of the video sources 60 but not in the filed of view of the virtual participant.

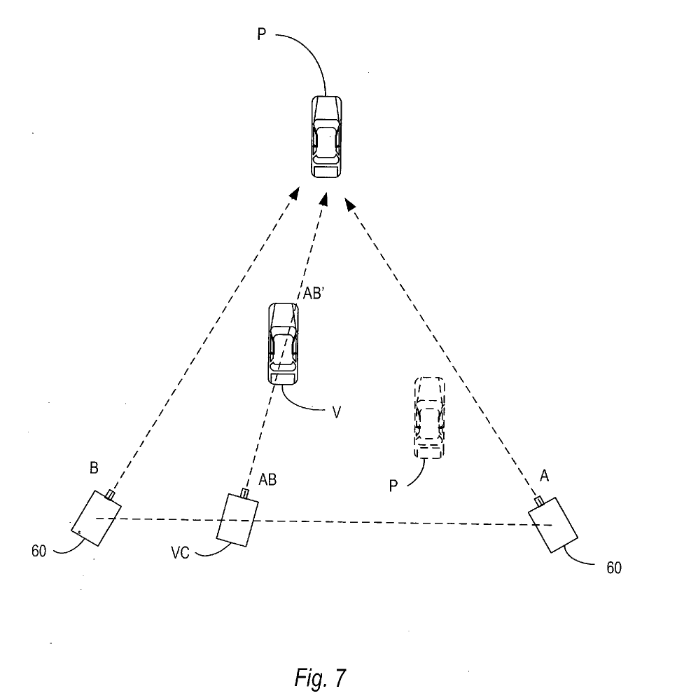

FIG. 7 illustrates an alternate technique for transforming video images from two video sources 60. In FIG. 7, video sources 60 provide views A and B respectively. The views A and B are first transformed using video morphing techniques described above to create an intermediate view AB from the perspective of a virtual video source. The intermediate AB is then scaled based on the distance of the real video sources 60, the virtual video source VC, and the virtual participant to objects in the filed of view of the real video sources.

In order to morph and/or combine images from multiple video sources 60, the video processor 56 needs to know the position and orientation of the video sources 60. Thus, the remote sensor 70 may include position and orientation sensors for each of the video sources 60. These position and orientation sensors provide output to the video processor 58 for use in performing view morphing operations as herein above described.

In some embodiments, the position and/or orientation of the video sources 60 may be fixed. For example, the video sources 60 may be mounted at strategic locations around the race track to capture the live event from many different viewpoints. Those skilled in the art will appreciate, however, that the position and/or orientation of the video sources 60 may be moveable. For example, video sources 60 may be mounted on race cars participating in the live event. Further, the orientation of some video sources 60 mounted in fixed locations may be varied to track the movement of the race cars participating in the live event.

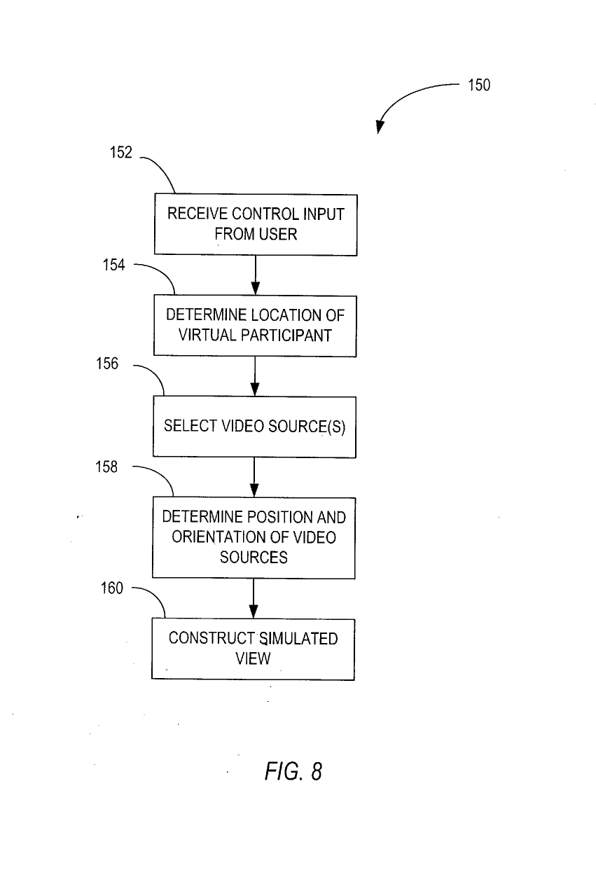

FIG. 8 illustrates an exemplary method 150 for generating a live event simulation according to one exemplary embodiment. The game server 50 receives control input from a user device 100 controlling a virtual participant in the live event simulation (block 152). Based on the control input from the user device 100, the game server 50 determines a position and/or orientation of a virtual participant controlled by the user (block 154) and selects one or more video sources 60 based on the position of the virtual participant (block 156). Additionally, the game server 50 determines the position and/or or orientation of each video source 60 based on input from the remote sensors 70 (block 158). The games server 50 then constructs a simulated view based on the position and/or orientation of the video sources 60 and the position and/or orientation of the virtual participant (block 160). As described above, the construction of a simulated view may involve transforming operations such as scaling a video feed from a selected video source, interpolating between corresponding points in two or more video images provided by different video sources, and/or scaling of an intermediate image generated by interpolation.

Additionally, the game server 50 may edit one or more of the video sources 60 prior to the transforming operations to eliminate objects in the view of one or more video sources 60 that are not in the view of the virtual participant in order to construct the simulated view. In the exemplary embodiment described above, a real race car trailing the simulated race car of a user may appear in the view of a video source 60. In this case, it may be necessary to edit the video image from the video source 60 prior to performing the transform operations.

In some embodiments, the construction of a simulated view may further require combining virtual elements with the video images from the video sources 60. For example, in a multiplayer game, one virtual participant may be in the view of another virtual participant. In this case, the game server 50 will need to generate a view of the virtual participant based on the event models to be added to the simulated view. That is view of one virtual element generated by the game server 50 based on the event models may be combined with the live video image from a video source 60.

Other computer-generated elements may also be added to a simulated view by the video processor 58. For example, the video processor 58 may add labels to the video image to indicate the name and/or position of participants, both real and virtual, against whom a user is racing. The labels may also provide feedback to the user regarding the performance of the virtual participant, such as the average speed, current position or standing, etc. The video processor may also add highlighting or other visual clues to aid the user in playing the game. For example, highlighting may be added to indicate the lead car in the race, or to identify other virtual participants.

Those skilled in the art will appreciate that the techniques described herein can be applied in real time to enable a user to participate in the live event while the event is taking place. However, the present invention may also be applied to recorded images of the live event at some time after the event has occurred.

1. A method of simulating participation in a live event, said method comprising:
receiving user input controlling a virtual participant in said live event;
determining a position of a virtual participant in the live event based on said user input;
selecting a video source based on the position of the virtual participant;
determining a position of the selected video source; and
transforming a video image from the selected video source based on the position of the selected video source and the position of the virtual participant to generate a simulated view from a viewpoint of the virtual participant.

2. The method of claim 1 wherein transforming a video image from the selected video source comprises scaling a video image provided by a single video source based on a distance of said virtual participant and a distance of said video source from one or more objects in the view of said video image.

3. The method of claim 2 further comprising editing said video image from said image source prior to transforming said video image to delete objects in the view of the video source but not in the view of the virtual participant.

4. The method of claim 1 wherein transforming a video image from the selected video source comprises interpolating between two or more video images from two or more selected video sources.

5. The method of claim 1 wherein transforming a video image from the selected video source comprises interpolating between two or more video images from two or more selected video sources to generate an intermediate view, and subsequently scaling the intermediate view based on a distance of said virtual participant and a distance of said intermediate view from one or more objects in the view of said video images.

6. The method of claim 5 further comprising editing said video image from said image source prior to transforming said video image to delete objects in the view of the video source but not in the view of the virtual participant.

7. The method of claim 1 further comprising determining an orientation of said virtual participant based on said user input.

8. The method of claim 7 wherein said transforming is further based on said orientation of said virtual participant and on an orientation of said video source.

9. The method of claim 1 further comprising combining virtual elements with said video image to generate said simulated view.

10. The method of claim 9 wherein combining virtual elements with said video image comprises combining a computer-generated image of a second virtual participant with said video image to create a simulated view for a first virtual participant.

11. An interactive media and game system for creating a live event simulation, said interactive media and game system comprising:
an event simulation processor configured to create a live event simulation and to determine a position of a virtual participant based on user input; and
a video processor configured to select a video source based on the position of the virtual participant, determine a position of the selected video source, and transform a video image from the selected video source based on the position of the selected video source and the position of the virtual participant to generate a simulated view from a viewpoint of the virtual participant.

12. The interactive media and game system of claim 11 wherein the video processor is configured to transform a video image from the selected video source by scaling a video image provided by a single video source based on a distance of said virtual participant and a distance of said video source from one or more objects in the view of said video image.

13. The interactive media and game system of claim 12 wherein the video processor is configured to edit said video image from said image source prior to transforming said video image to delete objects in the view of the video source but not in the view of the virtual participant.

14. The interactive media and game system of claim 11 wherein the video processor is configured to transform a video image from the selected video source by interpolating between two or more video images from two or more selected video sources.

15. The interactive media and game system 11 wherein the video processor is configured to transform a video image from the selected video source by interpolating between two or more video images from two or more selected video sources to generate an intermediate view and subsequently scaling the intermediate view based on a distance of said virtual participant and a distance of said intermediate view from one or more objects in the view of said video images.

16. The interactive media and game system of claim 15 wherein the video processor is configured to edit said video image from said image source prior to transforming said video image to delete objects in the view of the video source but not in the view of the virtual participant.

17. The interactive media and game system of claim 11 wherein said event simulation processor further determines an orientation of said virtual participant based on said user input.

18. The interactive media and game system of claim 17 wherein the video processor is further configured to transform said video image based on an orientation of said virtual participant and an orientation of said video source.

19. The interactive media and game system of claim 11 wherein the video processor is configured to combine virtual elements with said video image to generate said simulated view.

20. The interactive media and game system of claim 19 wherein said video processor is configured to combine a computer-generated image of a second virtual participant with said video image to create a simulated view for a first virtual participant.
